(19) United States
(12) Patent Application Publication
(10) Pub. No.: US 2018/0028019 A1
(43) Pub. Date: Feb. 1, 2018

(54) ROTATING CUP

(71) Applicant: KAI WEN HOU, Taipei (TW)

(72) Inventor: KAI WEN HOU, Taipei (TW)

(21) Appl. No.: 15/659,633

(22) Filed: Jul. 26, 2017

(30) Foreign Application Priority Data
Jul. 29, 2016 (TW) 105211487

(51) Int. Cl. A47J 43/046; B01F 9/00; A47J 43/07

(52) U.S. Cl. CPC A47J 43/046; A47J 43/07; B01F 9/00; A23V 2002/00

(57) ABSTRACT

A rotating cup, both hands implement relatively forward and backward rotation to generate agitation effect, for mixing powdered material with liquid and stirring food material, such as egg liquid, especially suitable for the open air. The rotating cup comprises an inner cup, a first outer cup and a second outer cup which are coaxially superposed. A fixed axle penetrates through the center of circle of the first outer cup, and both ends of the fixed axle are fixed to the centers of circle of inner cup and the second outer cup, so that the second outer cup and inner cup are interlocked, and the first outer cup can idle. The rotating cup can be equipped with a transmission structure and a stirring rod simultaneously or respectively. On the one hand to provide unidirectional rotation effect and acceleration effect for quick mixing, on the other hand to provide a better agitation effect.

### BACKGROUND OF INVENTION

### 1. Field of the Invention

The present invention relates generally to a cup with mixing effect, in other words, the relatively forward and backward rotation effects of both hands result in the mixing effect of cup, applicable to the mixing of powdered material and liquid and the mixing of food material, such as egg liquid.

### 2. Description of Related Art

Traditionally, to mix powdered material with liquid in a cup without a cover, a stirring rod is used for mixing. If the cup is provided with a cover, the cup is sealed and shaken repeatedly.

To mix the food material with egg liquid outdoors, besides a container, a stirring rod is required. The egg liquid cannot be mixed thoroughly only by shaking or rotation.

With technical progress, there have been electric mixing products which can be powered by the grid on the market, they save time and labor, but consume energy, and they cannot be used outdoors as they must be connected to the grid, the expedience and practicability are limited.

As the global energy shortage is increasingly severe, if the small articles pay attention to energy saving to stimulate the circles to develop more environmentally friendly commodities of the same type, that must be a positive contribution to the future society.

### SUMMARY OF THE INVENTION

The primary objective of the present invention is to provide a rotating cup, the powdered material and liquid are mixed quickly in the cup in an easy and labor-saving operation mode.

Another objective of the present invention is to provide a rotating cup, the mixing of powdered material and liquid in the cup is accelerated by forward and backward rotation effects of both hands with the restrictive effect on one rotation direction and the acceleration effect on continuous rotation.

Another objective of the present invention is to provide a rotating cup, combined with a detachable stirring rod, it perfects the mixing effect for different mixing requirements.

In order to attain said purposes, this inventor designs a rotating cup, comprising an inner cup, a first outer cup and a second outer cup, which are coaxially superposed, a fixed axle penetrates through the center of circle of the first outer cup, and both ends of the fixed axle are fixed to the centers of circle of inner cup and the second outer cup, so that the second outer cup and inner cup are interlocked, the first outer cup can rotate or idle.

Said rotating cup contains a cover body in random geometry, e.g. pancake or bullet shape.

Said rotating cup contains a transmission structure, located on the fixed axle which connects the inner cup, the first outer cup and the second outer cup, providing restrictive effect on one rotation direction and acceleration effect on continuous rotation.

Said transmission structure comprises a master gear, a gear shaft, a pinion and a ratchet engaging with each other. The master gear is fitted over the fixed axle, fixed to the center of inner circle of the second outer cup, the ratchet is embedded in the ratchet level at the bottom of inner cup, fitted over the fixed axle.

There is a stirring rod in the inner cup of said rotating cup, the stirring rod is positioned by magnetic attraction.

### BRIEF DESCRIPTION OF THE DRAWINGS

FIG. 1 is the perspective view of rotating cup of a preferred embodiment.

FIG. 2 is the schematic diagram of two appearances of rotating cup of a preferred embodiment.

FIG. 3 is the perspective view of rotating cup of another preferred embodiment.

FIG. 4 is the schematic diagram of transmission structure of rotating cup of another preferred embodiment.

FIG. 5 is the perspective view of two inner cups of rotating cup of another preferred embodiment.

### DETAILED DESCRIPTION OF THE INVENTION

The present invention provides a novel and creative rotating cup, both hands hold the cup forward and backward, and rotate the cup forward and backward simultaneously, so as to make mixing effect of the cup. It can be used for mixing powdered material and liquid without any additional stirrers, especially suitable for the open air.

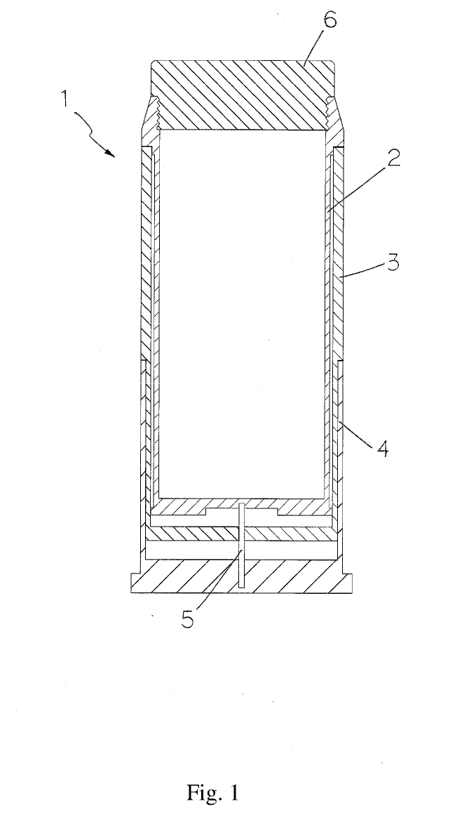

The detail construction of the rotating cup 1 is shown in FIG. 1, comprising an inner cup 2, a first outer cup 3, a second outer cup 4 and a cover body 6. The cup bodies are coaxially superposed, a fixed axle 5 penetrates through the center of circle of the first outer cup 3, and both ends of the fixed axle 5 are fixed to the centers of circle of the inner cup 2 and the second outer cup 4, so that the second outer cup 4 and the inner cup 2 are interlocked, the first outer cup 3 can rotate or idle.

Therefore, when the first outer cup 3 and the second outer cup 4 are held by hands respectively, both hands implement relatively forward and backward rotation simultaneously, or rotating the second outer cup 4 continuously taking the first outer cup 3 as pivot, the inner cup 2 is driven by the second outer cup 4.

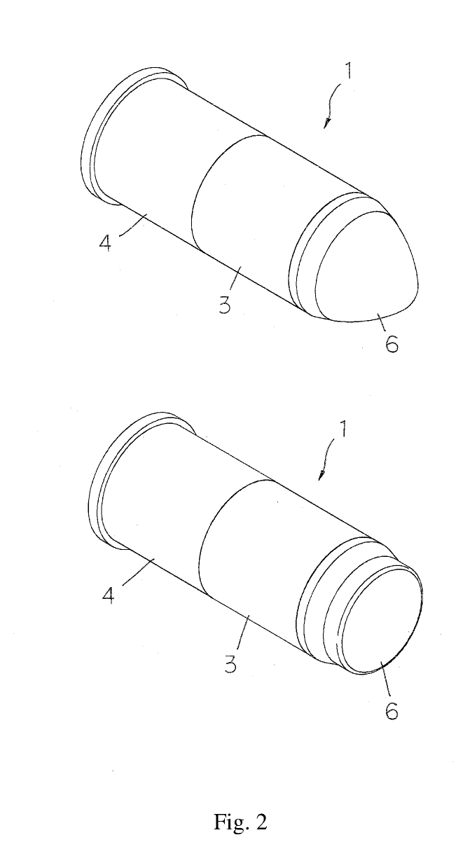

The cover body 6 of the rotating cup 1, as shown in FIG. 2, can be in any geometry, such as a flat shape or a bullet shape. The bullet shaped cover body 6 and the first outer cup 3 and the second outer cup 4 form a bullet body shape, forming a complete bullet shaped rotating cup 1, there are novel visual effect and particular style. The cover body 6 can be simply screwed on the rim of inner cup 2 for rapid combination or separation.

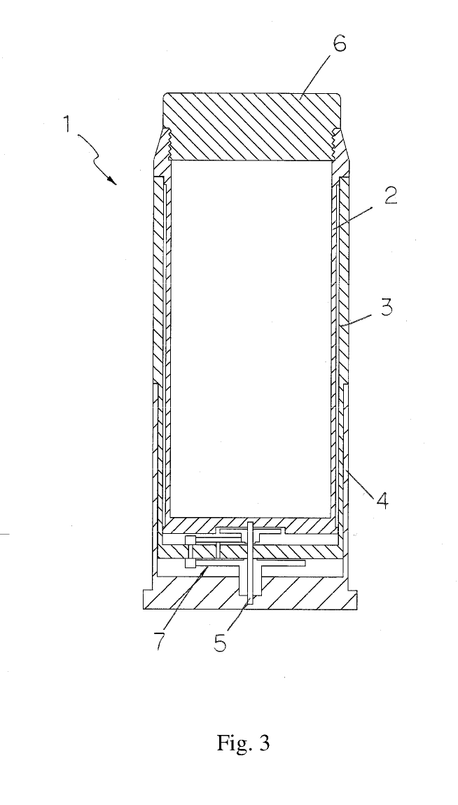

As shown in FIG. 3, in order to enhance said simple agitation effect, there is a transmission structure 7 on the fixed axle 5 through the cup bodies, and the fixed axle 5 only provides a support effect (both ends are not fixed to inner cup 2 and the second outer cup 4, to provide restrictive effect on one rotation direction of inner cup and acceleration effect on continuous rotation, the powdered material and liquid are mixed quickly.

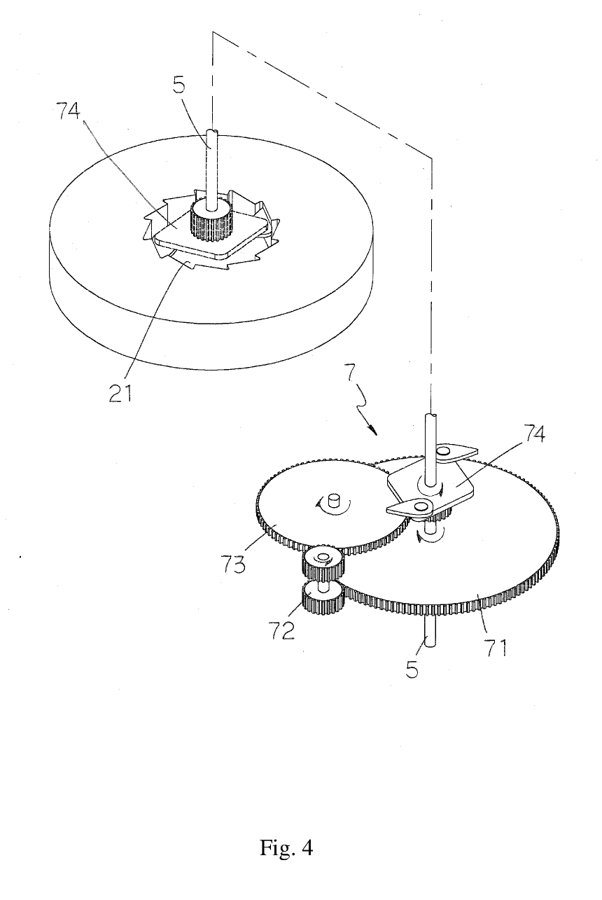

As shown in FIG. 4, the transmission structure 7 at least comprises a master gear 71, a gear shaft 72, a pinion 73 and a ratchet 74 engaging with each other. The master gear 71 is fitted over the fixed axle 5, fixed to the center of inner circle of the second outer cup 4. The ratchet 74 is embedded in the ratchet level 21 at the bottom of inner cup 2, fitted over the fixed axle 5.

The operation of the rotating cup 1 with transmission structure 7 is shown in FIG. 3 and FIG. 4. When the first outer cup 3 and the second outer cup 4 are held by both hands respectively, the hands implement relatively forward and backward rotation simultaneously, or the second outer cup 4 is rotated repeated taking the first outer cup 3 as pivot, the inner cup 2 can be driven by the connection between the second outer cup 4 and transmission gear 7. Due to the engaged transmission of master gear 71, gear 72 and pinion 73 of transmission gear 7 and the unidirectional rotation effect of ratchet 74, both hands can hold the first outer cup 3 and the second outer cup 4 simultaneously for forward and backward rotation without neutralization, but generating acceleration effect, the rotation is accelerated continuously, contributing to the accelerated mixing effect of inner cup 2.

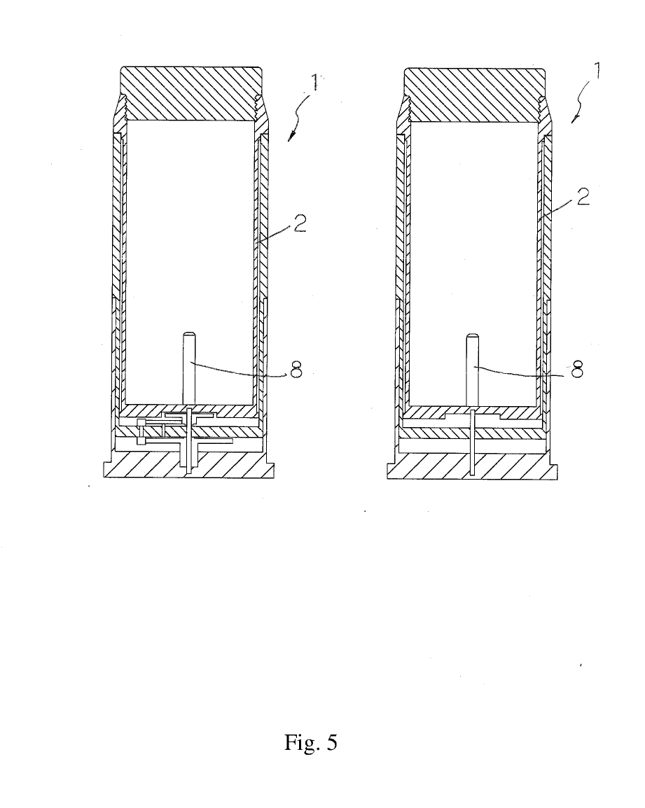

Added to this, the rotating cup 1 of the present invention responds to different mixing requirements. To stir egg liquid uniformly, please see FIG. 5, a magnetic stirring rod 8 can be mounted, its length is not limited, but not exceeding the height of inner cup 2, the inner bottom face of the inner cup 2 is positioned by magnetic attraction. Besides the rotation effect of the inner cup 2, the agitation effect of the stirring rod 8 formed with the rotation can further perfect the mixing of egg liquid.

The embodiment of the present invention described above is to be regarded in all respects as being illustrative and nonrestrictive. Accordingly, the present invention may be embodied in other specific forms without deviating from the spirit thereof. The present invention is therefore to be limited only by the scopes of the following claims.

1. A rotating cup comprises an inner cup, a first outer cup and a second outer cup, which are coaxially superposed, a fixed axle penetrates through the center of circle of the first outer cup, and both ends of the fixed axle are fixed to the centers of circle of inner cup and the second outer cup, so that the second outer cup and inner cup are interlocked, the first outer cup can rotate or idle.

2. The rotating cup as claimed in claim 1, wherein the rotating cup contains a cover body, which can be in any geometry, e.g. flat or bullet shape.

3. The rotating cup as claimed in claim 1, wherein the rotating cup contains a transmission structure, mounted on the fixed axle connecting the inner cup, the first outer cup and the second outer cup.

4. The rotating cup as claimed in claim 3, wherein the transmission structure comprises a master gear, a gear shaft, a pinion and a ratchet engaging with each other. The master gear is fitted over the fixed axle and fixed to the center of inner circle of the second outer cup. The ratchet is embedded in the ratchet level at the bottom of inner cup, and fitted over the fixed axle.

5. The rotating cup as claimed in claim 1, wherein there is a stirring rod on the inner bottom face of inner cup, positioned by magnetic attraction.
